(19) United States
(12) Patent Application Publication
(10) Pub. No.: US 2022/0334863 A1
(43) Pub. Date: Oct. 20, 2022

(54) STORAGE SYSTEM, INSTALLATION METHOD, AND RECORDING MEDIUM

(71) Applicant: Hitachi, Ltd., Tokyo (JP)

(72) Inventors: Hiroshi MIKI, Tokyo (JP); Naoya HATTORI, Tokyo (JP); Tomohiro SHINOHARA, Tokyo (JP)

(73) Assignee: Hitachi, Ltd.

(21) Appl. No.: 17/465,560

(22) Filed: Sep. 2, 2021

(30) Foreign Application Priority Data
Apr. 16, 2021 (JP) 2021-069955

(51) Int. Cl. G06F 9/455

(52) U.S. Cl. CPC G06F 9/45558; G06F 2009/45595; G06F 2009/45583; G06F 2009/45562

(57) ABSTRACT

When a cluster is configured by hypervisors of a plurality of servers, a shared storage including internal storages of the plurality of servers can be used. In a storage system in which a hypervisor managing VMs on each of the plurality of servers is included and the plurality of hypervisors configures a cluster, the plurality of servers each include a storage VM that provides the shared storage. One of the plurality of servers includes a manager VM that manages the hypervisors of the plurality of servers as the cluster. A virtual volume of the shared storage is provided as an LU for constructing the manager VM.

### CROSS-REFERENCE TO RELATED APPLICATIONS

This application claims priority from Japanese Patent Application No. 2021-069955 filed Apr. 16, 2021. The entire content of the priority application is incorporated herein by reference.

### BACKGROUND

The present disclosure relates to a storage system or the like that configures a cluster by hypervisors of a plurality of physical servers.

For example, an HCI (Hyper-Converged Infrastructure) system is known that includes a plurality of physical servers realized by virtualizing infrastructure functions of storages or network devices. As HCI systems, systems in which hypervisor managing virtual machines (VMs) is generated in each of a plurality of physical servers and a cluster is configured by the hypervisors of the plurality of physical servers, are known. In such HCI systems, a manager VM managing the cluster of the hypervisors are provided in any of the physical servers.

For example, as such an HCI system, a RedHat Hyperconverged Infrastructure (RHHI) disclosed in Deploy of RedHat Hyperconverged Infrastructure, the Internet https://access.redhat.com/documentation/ja-jp/red hat_hyperconverged_infrastructure for virtualization/1.0/html/deploying_red_hat_hyperconverged_infrastructure/Archite cture> is known.

### SUMMARY

For example, when a shared storage which can be shared by a plurality of servers is used in the HCI system such as the RHHI, it is necessary to construct a storage VM that has a function of providing the shared storage in each server.

However, when the storage VM is constructed to use the shared storage in the HCI system, there is a problem that the storage VM may not configure the shared storage in internal storages of the servers included in the HCI system and an external storage have to be used.

The present disclosure has been devised in view of the foregoing circumstances and an objective of the present disclosure is to provide a technology for using a shared storage configured to include internal storages of a plurality of servers when a cluster is configured by hypervisors of the plurality of servers.

To achieve the foregoing objective, a storage system according to an aspect includes a plurality of physical servers each including a hypervisor configured to manage a virtual machine on each of a plurality of physical servers, the plurality of hypervisors configuring a cluster. The plurality of physical servers each include a storage virtual machine that provides a shared storage. One of the plurality of physical servers includes a management virtual machine that manages the hypervisors of the plurality of physical servers as the cluster. A virtual volume of the shared storage is provided as a virtual volume for constructing the management virtual machine.

### BRIEF DESCRIPTION OF THE DRAWINGS

FIG. 1 is a diagram illustrating an overall configuration of a storage system according to an embodiment;

FIG. 2 is a diagram illustrating a configuration of a server according to an embodiment;

FIG. 3 is a diagram illustrating an overview of provision of an LU in a storage system according to an embodiment;

FIG. 4 is a first flowchart illustrating an installation process according to an embodiment;

FIG. 5 is a second flowchart illustrating an installation process according to an embodiment;

FIG. 6 is a diagram illustrating a configuration of network configuration information in a server 1 according to an embodiment;

FIG. 7 is a diagram illustrating a configuration of network configuration information in a server 2 according to an embodiment; and

FIG. 8 is a diagram illustrating a configuration of a VM configuration management table according to an embodiment.

### DETAILED DESCRIPTION OF THE EMBODIMENT

Embodiments will be described with reference to the drawings. The embodiments to be described below do not limit the inventions of the claims, and all the elements described in the embodiments and all combinations of the elements are not necessarily essential to solutions of the present invention.

In the following description, information will be described with an expression of an “AAA table,” but the information may be expressed with any data structure. That is, to indicate that information does not depend on a data structure, an “AAA table” can be referred to as “AAA information.”

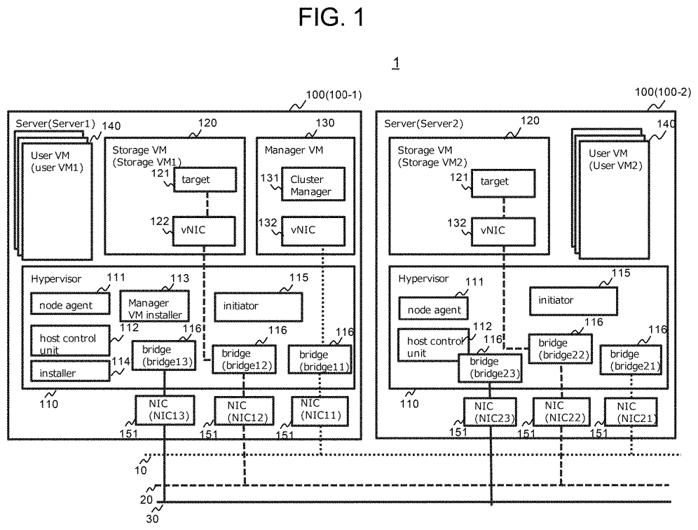

FIG. 1 is a diagram illustrating an overall configuration of a storage system according to an embodiment.

A storage system 1 includes a plurality of servers 100 (100-1 and 100-2). The plurality of servers 100 are coupled to be able to communicate with each other via a management network 10, an iSCSI network 20, and a user network 30.

The management network 10, the iSCSI network 20, and the user network 30 are, for example, communication networks such as a wired LAN (Local Area Network), a wireless LAN, a WAN (Wide Area Network), and the like. In the embodiment, the management network 10, the iSCSI network 20, and the user network 30 are assumed to be different networks, but any of the plurality of networks may be identical networks, for example.

The server 100 is a physical computer and includes a hypervisor 110, a storage VM 120, a manager VM 130, one or more user VMs 140, and one or more NICs (Network Interface Cards) 151 which are example of communication interfaces. The manager VM 130 is included in only a server 100-1 (server 1) which is a representative, and is not included in the other server 100-2 (server 2) which is not a representative.

The hypervisor 110 controls construction of the VMs in the server 100, deletion of the VM in the server, and allocation of resources to VMs.

The hypervisor 110 includes a node agent 111, a host control unit 112, a manager VM installer 113, an installer 114, an initiator 115, and a plurality of bridges 116 as functional units. In the hypervisor 110, for example, Linux (registered trademark) is used as an OS (Operating system) and a KVM (Kernel-based Virtual Machine) is used therefor. The hypervisor 110 can be constructed by further adding modules realizing the installer 114, and the host control unit 112, or the like. The installer 114 and the manager VM installer 113 may be included in only the server 100 that is a representative.

The node agent 111 performs communication with a cluster manager 131 of the manager VM 130 and performs various processes (for example, construction of the user VM 140) or the like. The host control unit 112 performs a process of configuring a network in the hypervisor 110 and a process of constructing the storage VM 120. The manager VM installer 113 performs a process of constructing the manager VM 130. The installer 114 generally controls configuring of a network in the hypervisor 110, construction (generation) of the storage VM 120, construction of the manager VM 130, construction of the user VM 140, and the like. The initiator 115 performs a process of issuing an I/O request for data to a target 121 to be described below, or the like. The bridge 116 relays communication between virtual NIC (122, 132) and the NIC 151.

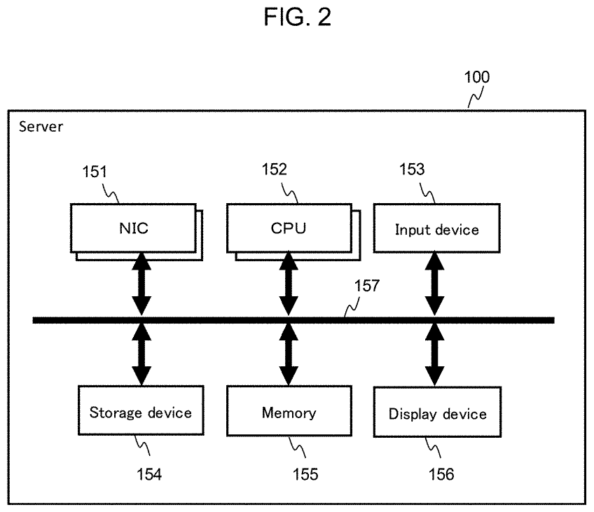

The storage VM 120 has a function of performing I/O on an internal storage device 154 (see FIG. 2) or an external storage device of the server 100 and provides storage areas of these devices as volumes. The storage VM 120 configures a cluster along with the storage VMs 120 of the other servers 100 to configure a shared storage which each storage VM 120 can access using a storage device on which each storage VM 120 can perform I/O. The storage VM 120 includes the target 121 and a virtual NIC (vNIC) 122.

The target 121 performs an I/O process on the storage device configuring the shared storage according to an I/O request from the initiator 115. The virtual NIC 122 is an interface that relays communication in the storage VM 120 and is coupled to the NIC 151 via the bridge 116 of the hypervisor 110.

The manager VM 130 performs a process of managing a cluster constructed by the hypervisors 110 of the plurality of servers 100. The manager VM 130 includes a cluster manager 131 and a virtual NIC (vNIC) 132.

The cluster manager 131 performs a process of generally managing resources of the network, the VM, the hypervisor 110, and the like in the cluster. The virtual NIC 132 is an interface that relays communication in the manager VM 130 and is coupled to the NIC 151 via the bridge 116 of the hypervisor 110.

The user VM 140 performs a process of providing a file service to a terminal used by a user.

The NIC 151 is an example of a communication interface and communicates with other apparatuses (the other servers 100 or the like) via networks (10, 20, and 30).

FIG. 2 is a diagram illustrating a configuration of the server according to an embodiment.

The server 100 (100-1, 100-2) is configured by, for example, a physical server such as a PC (Personal Computer) or a general-purpose server. The server 100 includes resources such as the plurality of NICs 151, one or more CPUs (Central Processing Units) 152, an input device 153, a storage device 154, a memory 155, and a display device 156.

The CPU 152 performs various processes in accordance with programs stored in the memory 155 and/or the storage device 154. In the embodiment, the CPU 152 is allocated to each VM. Units of allocation to each VM may be the number of CPUs 152. For example, in the hypervisor 110, each functional unit is configured by the CPU 152 executes the program.

The memory 155 is, for example, a RAM (RANDOM ACCESS MEMORY) and stores necessary information or programs which are executed by the CPU 152. In the embodiment, the memory 155 is allocated to each VM for usage.

The storage device 154 is, for example, a hard disk, a flash memory, or the like and stores a program executed by the CPU 152, data used in the CPU 152, files of user data used by clients, and the like. The storage device 154 is also referred to as an internal storage. In the embodiment, the storage device 154 stores a program for realizing the hypervisor 110 (for example, an installation program for configuring the installer 114 and the host control unit 112, or the like), programs for causing the VMs generated by the hypervisor 110 to function as the storage VM 120, the manager VM 130, and the user VM 140, and the like.

The input device 153 is, for example, a mouse, a keyboard, or the like and receives information input by an administrator of the server. The display device 156 is, for example, a display, and displays and outputs various kinds of information.

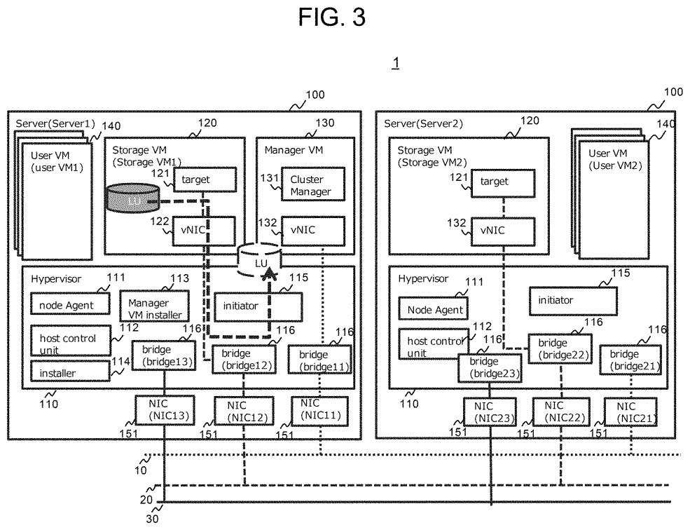

FIG. 3 is a diagram illustrating an overview of provision of an LU in a storage system according to an embodiment.

In the storage system 1, the storage VM 120 is constructed before the manager VM 130 and a cluster of the storage VMs 120 is configured by the storage VMs 120 of the plurality of servers 100. The shared storage is configured using the internal storage by the cluster of the storage VMs 120. Subsequently, an LU (logical unit and a virtual volume) of the shared storage configured by the cluster of the storage VMs 120 is allocated to the manager VM 130 so that the manager VM 130 is constructed.

In this way, in the storage system 1, the manager VM 130 can be constructed by using the LU using the internal storage.

Next, an installation process of constructing the storage VM 120, the manager VM 130, and the user VM 140 in the storage system 1 will be described. In the storage system 1 before the installation process is performed, the storage VM 120, the manager VM 130, the user VM 140, and the bridge 116 illustrated in FIG. 1 are not present.

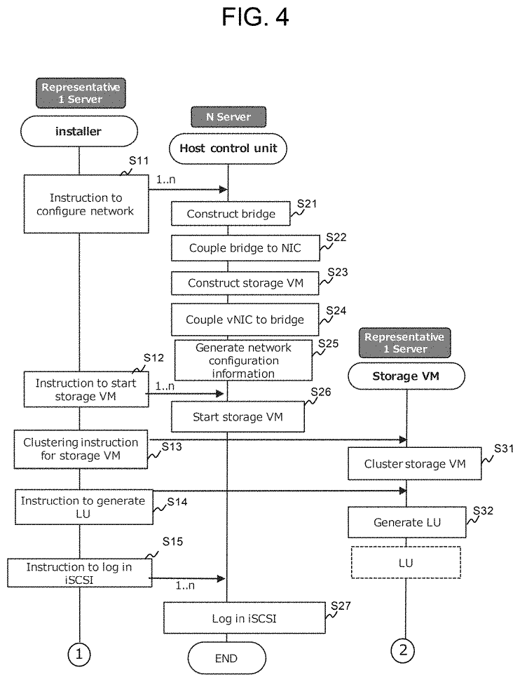

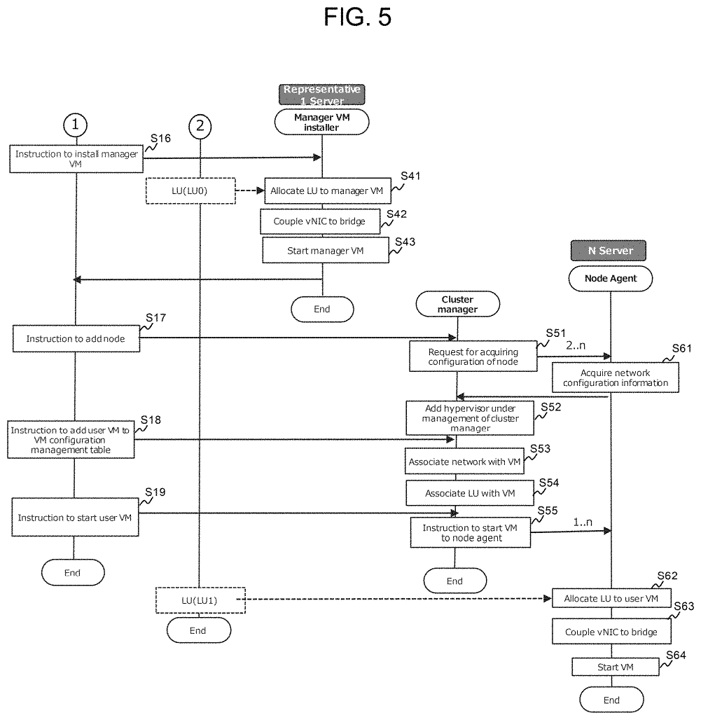

FIG. 4 is a first flowchart illustrating an installation process according to an embodiment and FIG. 5 is a second flowchart illustrating an installation process according to an embodiment.

The installer 114 of one server 100 (referred to as a representative server) which is a representative in the installation process of the storage system 1 transmits an instruction to configure a network in each server 100 to the host control units 112 of the hypervisors 110 of 1 to n (where n indicates the number of servers configuring the cluster) servers 100 (step S11).

In response to this, the host control unit 112 of each server 100 performs processes of steps S21 to S25. Specifically, the host control unit 112 constructs the plurality of bridges 116 (step S21), logically couples each of the constructed bridges 116 to the NIC 151 of the server 100 (step S22), and constructs the storage VM 120 (step S23). Thus, a storage area of the internal storage device 154 which can be used as the shared storage is allocated to the storage VM 120.

Subsequently, the host control unit 112 logically couples the virtual NIC 122 of the storage VM 120 to the bridge 116 (step S24). For example, information regarding the logical coupling between the virtual NIC 122 and the bridge 116 is configured in the OS of the storage VM 120.

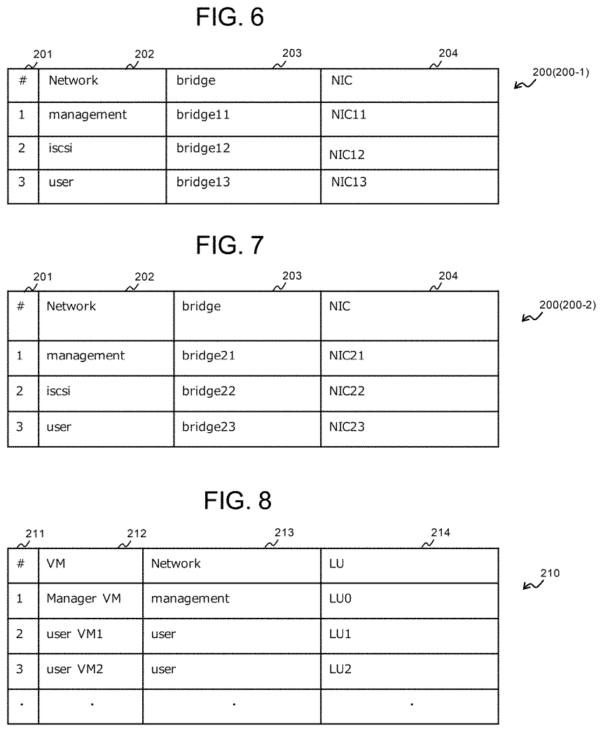

Subsequently, the host control unit 112 generates network configuration information 200 (see FIGS. 6 and 7) indicating a coupling relation between the networks 10, 20, and 30, the NICs 151, and the bridges 116 so the node agent 111 is stored to be referred to (step S25).

Here, the network configuration information 200 will be described.

FIG. 6 is a diagram illustrating a configuration of a network configuration information in a server 1 according to an embodiment and FIG. 7 is a diagram illustrating a configuration of a network configuration information in a server 2 according to an embodiment.

The network configuration information 200 includes an entry for each coupling relation, as illustrated in FIGS. 6 and 7. The entry of the network configuration information 200 includes fields of a number (#) 201, a network 202, a bridge 203, and an NIC 204.

In the number 201, an entry number is stored. In the network 202, identification information of the network in the coupling relation corresponding to the entry is stored. In the bridge 203, identification information of the bridge 116 in the coupling relation corresponding to the entry is stored. In the NIC 204, identification information of the NIC 151 in the coupling relation corresponding to the entry is stored.

For example, network configuration information 200-1 illustrated in FIG. 6 indicates that NIC 11 is coupled to the management network 10, Bridge 11 is coupled to the NIC 11, NIC 12 is coupled to the iSCSI network 20, Bridge 12 is coupled to NIC 12, NIC 13 is coupled to the user network 30, and Bridge 13 is coupled to NIC 13. Network configuration information 200-2 illustrated in FIG. 7 indicates that NIC 21 is coupled to the management network 10, Bridge 21 is coupled to NIC 21, NIC 22 is coupled to the iSCSI network 20, Bridge 22 is coupled to NIC 22, NIC 23 is coupled to the user network 30, and Bridge 23 is coupled to NIC 23.

Referring back to FIG. 4, the installer 114 transmits an instruction to start the storage VM 120 to the host control unit 112 of each server 100 (step S12).

In response to this, the host control unit 112 of each server 100 starts the storage VM 120 (step S26). Thus, in each server 100, the storage VM 120 can perform processes.

Subsequently, the installer 114 transmits an instruction to configure the cluster of the storage VMs 120 (a clustering instruction) to the storage VM 120 of any one server 100 (step S13).

In response to this, the storage VM 120 of the server 100 to which the clustering instruction has been transmitted configures the cluster (a storage cluster) in cooperation with the storage VMs 120 of the servers 100 which are cluster configuration targets (step S31).

Subsequently, the installer 114 transmits an instruction to generate the LU (an LU generation instruction) to the storage VM 120 of one server 100 (step S14).

In response to this, the storage VM 120 of the server 100 to which the LU generation instruction has been transmitted generates the LU based on the storage area of the shared storage provided by the storage VM 120 configuring the cluster (step S32).

Subsequently, the installer 114 transmits an instruction to log in the iSCSI to the host control unit 112 of each server 100 (step S15).

In response to this, the host control unit 112 of each server 100 performs logging-in of the iSCSI on the storage VM 120 (step S27). Thus, it is possible to access the LU provided by the storage VM 120 from the hypervisor 110.

Subsequently, as illustrated in FIG. 5, the installer 114 transmits an instruction to install the manager VM 130 to the manager VM installer 113 of the representative server (step S16).

In response to this, the manager VM installer 113 to which the installation instruction has been transmitted allocates the LU (for example, LU0) provided by the storage VM 120 to the manager VM and installs the manager VM 130 (step S41), couples the vNIC 132 of the manager VM 130 to the bridge 116 of the hypervisor 110 (step S42), and starts the manager VM 130 (step S43).

Subsequently, the installer 114 transmits an instruction to add a server (node) configuring the cluster of the hypervisors 110 to the cluster manager 131 of the manager VM 130 of the representative server (step S17).

In response to this, the cluster manager 131 transmits a request for acquiring the configuration information to the node agent 111 of the other servers 100 configuring the cluster (step S51).

The node agent 111 of each server 100 which has received the acquisition request acquires the network configuration information of the server 100 (step S61) and transmits the network configuration information to the cluster manager 131.

The cluster manager 131 stores the network configuration information acquired from each server 100 and adds the hypervisors 110 of the other servers 100 under management of the cluster manager 131 (step S52). Thus, the cluster manager 131 can manage the hypervisor 110 of each server 100 as the cluster. Since the network configuration information of each server 100 is acquired, the VM of which generation has been managed by the cluster manager 131 can be appropriately coupled to the network.

After step S17, the installer 114 transmits an instruction to add information regarding the user VM 140 which is a generation target to a VM configuration management table 210 (see FIG. 8) to the cluster manager 131 (step S18).

In response to this, the cluster manager 131 adds an entry of the user VM 140 which is a generation target to the VM configuration management table 210, stores identification information of the network associated with the user VM 140 in that entry (step S53), and further stores identification information of the LU associated with the user VM 140 (step S54).

Here, the VM configuration management table 210 will be described.

FIG. 8 is a diagram illustrating a configuration of a VM configuration management table according to an embodiment.

The VM configuration management table 210 is stored in, for example, the storage device 154 allocated to the manager VM 130. The VM configuration management table 210 manages the configuration information of the manager VM 130 and the user VM 140 generated in response to the instruction from the manager VM 130. The VM configuration management table 210 includes an entry for each manager VM which is a management target. The entry of the VM configuration management table 210 includes fields of a number (#) 211, a VM 212, a network 213, and an LU 214.

In the number 211, an entry number is stored. In the VM 212, identification information of the VM corresponding to the entry is stored. In the network 213, identification information of the network to which the VM corresponding to the entry is coupled is stored. In the LU 214, identification information of the LU allocated to the VM corresponding to the entry is stored.

For example, the VM configuration management table 210 illustrated in FIG. 8 indicates that the manager VM 130 is coupled to the management network 10 and LU0 is allocated, user VM1 is coupled to the user network 30 and LU1 is allocated, and user VM2 is coupled to the user network 30 and LU2 is allocated.

Referring back to FIG. 5, after step S18, the installer 114 transmits an instruction to start the user VM 140 in each server 100 to the cluster manager 131 (step S19) and ends the process.

The cluster manager 131 transmits an instruction to start the user VM 140 which has received the starting instruction to each node agent 111 of each server 100 (step S55). The starting instruction includes identification information of the LU allocated to the user VM 140.

The node agent 111 allocates the LU to the user VM 140 to which the starting instruction has been transmitted, installs the user VM 140 (step S62), couples the virtual NIC of the user VM 140 to the bridge 116 of the hypervisor 110 (step S63), starts the user VM 140 (step S64), and ends the process.

When there are the plurality of user VMs 140 which are generation targets, the installer 114 repeatedly performs the processes of steps S18 to S19, and the cluster manager 131 and each node agent 111 performs the similar processes (steps S53 to S55 and S62 to S64) in response to the instructions.

Through the installation process, the storage system 1 illustrated in FIG. 1 is constructed.

As described above, through the foregoing installation process, the LU based on the shared storage provided by the storage VM 120 can be allocated to the manager VM 130. The LU based on the shared storage can be allocated to the VM of which the generation is managed by the manager VM 130.

The present invention is not limited to the foregoing embodiments and can be appropriately modified within the scope of the present invention without departing from the gist of the present invention.

For example, in the foregoing embodiments, as exemplified above, the shared storage of the storage system 1 is configured by only the storage devices of the plurality of servers 100 that include the hypervisors 110 configuring the cluster, but the present invention is not limited thereto. The shared storage may be configured including the storage devices coupled to the networks.

In the foregoing embodiments, the installer 114 is included in the hypervisor 110 that configures the cluster, but the present invention is not limited thereto. For example, the installer 114 may be included in a server or the like that does not include the hypervisor 110 that configures the cluster.

In the foregoing embodiments, some or all of the processes performed by the CPU may be performed by a hardware circuit. The program according to the foregoing embodiments may be installed from a program source. The program source may be a program distribution server or a recording medium (for example, a portable recording medium).

What is claimed is:

1. A storage system comprising:
a plurality of physical servers each including a hypervisor configured to manage a virtual machine on each of a plurality of physical servers, the plurality of hypervisors configuring a cluster, wherein
the plurality of physical servers each include a storage virtual machine that provides a shared storage,
one of the plurality of physical servers includes a management virtual machine that manages the hypervisors of the plurality of physical servers as the cluster, and
a virtual volume of the shared storage is provided as a virtual volume for constructing the management virtual machine.

2. The storage system according to claim 1, wherein
the storage system comprises an installer configured to perform control such that the storage virtual machine and the management virtual machine are constructed, and
the installer causes the plurality of physical servers to construct the storage virtual machines,
constructs a storage cluster which provides the shared storage by the storage virtual machine of the plurality of physical servers,
causes the storage virtual machine to generate a virtual volume, and
constructs the management virtual machine using the virtual volume.

3. The storage system according to claim 2, wherein
the hypervisor includes a management virtual machine installer that constructs the management virtual machine, and
the installer causes the management virtual machine installer to construct the management virtual machine.

4. The storage system according to claim 3, wherein the installer causes the management virtual machine installer to construct the cluster using the plurality of hypervisors.

5. The storage system according to claim 4, wherein
the installer couples, to each of the hypervisors, a communication interface allocated to the hypervisor and a bridge for coupling to the virtual machine on the physical server on which the hypervisor is operating, and stores network configuration information including a correspondence relation between the communication interface and the bridge, and
the management virtual machine acquires the network configuration information from the hypervisor and allocates the virtual volume to the plurality of hypervisors based on the network configuration information to construct a virtual machine of a predetermined generation target.

6. An installation method by a storage system constructing a management virtual machine that manages a plurality of hypervisors constructed in a plurality of physical servers as a cluster in one of the physical servers, the method comprising:
constructing a storage virtual machine in the physical server in which the hypervisor is configured, for each hypervisor;
starting the storage virtual machine;
configuring a cluster which are able to use a shared storage by the storage virtual machine of the plurality of physical servers;
generating a virtual volume in which the management virtual machine is constructed by the storage virtual machine of the physical server in which the management virtual machine is configured; and
constructing the management virtual machine on the virtual volume.

7. The installation method according to claim 6, wherein
the management virtual machine is started, and
the management virtual machine configures a cluster using the plurality of hypervisors.

8. A non-transitory computer-readable recording medium that records an installation program causing a computer to perform a process of constructing a management virtual machine that manages a plurality of hypervisors constructed in a plurality of physical servers as a cluster in one of the physical servers, wherein the installation program causes the computer to perform:
constructing a storage virtual machine in the physical server in which the hypervisor is configured, for each hypervisor;
starting the storage virtual machine;
configuring a cluster which are able to use a shared storage by the storage virtual machines of the plurality of physical servers;
generating a virtual volume in which the management virtual machine is constructed by the storage virtual machine of the physical server in which the management virtual machine is configured; and
constructing the management virtual machine on the virtual volume.

9. The recording medium according to claim 8, wherein the installation program causes the computer to start the management virtual machine, and cause the management virtual machine to configure a cluster using the plurality of hypervisors.
